(19) United States
(12) Patent Application Publication
(10) Pub. No.: US 2021/0352896 A1
(43) Pub. Date: Nov. 18, 2021

(54) Treatment of Plants or Fungi Against Disease

(71) Applicant: Henry Manufacturing Limited, Auckland (NZ)

(72) Inventor: Christopher Henry, Hastings (NZ)

(21) Appl. No.: 17/285,321

(22) PCT Filed: Sep. 13, 2019
(86) PCT No.: PCT/NZ2019/050123

§ 371 Date: Apr. 14, 2021

(30) Foreign Application Priority Data
Nov. 5, 2018 (NZ) 748004
May 15, 2019 (NZ) 753590

(51) Int. Cl. A01N 37/02; A01N 37/06; A01N 59/00

(52) U.S. Cl. CPC A01N 37/02; A01N 59/00; A01N 37/06

(57) ABSTRACT

A method of treating a plant against disease resulting from Pseudomonas bacteria or Monilinia fungi, comprising applying to the plant a fatty acid and a silicate.

### FIELD OF THE INVENTION

A preferred form of the invention relates to the treatment of plants against disease caused by pathogens of the family Pseudomonadaceae (for example Pseudomonas bacteria), or fungal pathogens of the family Sclerotiniaceae (for example Monilinia fungi).

A particularly preferred form of the invention relates to the treatment of stone-fruit trees and their fruit to prevent or reduce infection by bacterial blast and canker caused by Pseudomonas syringae pv. syringae, or to prevent or reduce brown rot caused by Monilinia fructicola.

### BACKGROUND

Averting plant diseases is an ongoing battle in the agricultural and horticultural industries. Some diseases are minor; however others present a serious problem causing significant adverse economic impact. Diseases caused by Pseudomonas syringae and Monilinia fructicola are of particular concern to growers of a wide range of crops including, but not limited to, kiwifruit, stone-fruit, tomatoes, potatoes and apples.

In the case of stone-fruit, two types of disease associated with Pseudomonas syringae pv syringae are bacterial blast and bacterial canker. Bacterial blast commonly infects blossoms however green stems and leaves may also be affected. It may for example cause blossoms and fruitlets to abort, plant tissues to turn brown or black, and infected leaves may appear spotty as a result of affected green tissues appearing in patches alongside unaffected tissues. Bacterial canker commonly manifests as small areas of dead tissue on tree branches (eg branchlets). It tends to spread over time and may infect the tree's vascular system causing a significant decline in the health of the tree, and even death. Infected tree parts also serve as a source of inoculum for new infections. Treating canker can be difficult and time consuming, and often the only viable option is to prune affected parts completely, or even remove the plant to stop spread of the disease.

Similarly for stone fruit, a disease associated with the fungus Monilinia fructicola is brown rot. It can be one of the most destructive diseases to stone fruit such as peaches, nectarines, apricots, cherries and plums. Monilinia fructicola often colonises blossom twigs on stone fruit trees. It also affects pome fruit trees and their fruit, such as pears.

Spraying agricultural treatments is one of the more effective methods for managing infection by Pseudomonas syringae pv syringae or Monilinia fructicola. Known sprays include copper-based fungicides. However in general they cannot be used long term as they may lead to undesirable levels of copper accumulating in the surrounding soil. Further, Pseudomonas bacteria can become resistant to copper in certain crops, therefore requiring higher rates to keep control of the disease. Copper can also be quite toxic to certain important soil organisms.

Current treatments for bacterial blast or canker include antibiotics such as streptomycin and kasugamycin. There is a relatively limited range of antibiotics available for treatment of plant diseases, and their long-term use heightens the risk of plants becoming resistant to them. Additionally there are often objections to these treatments based on the fear of humans acquiring resistance to the antibiotics, ie through consuming food produced using them.

There are some so-called ‘soft’ pesticide alternatives that require no withholding period because of their lack of any significant residual toxicity. Many are in the category of ‘biologicals’, which are organisms that prevent or influence the disease. In many cases, when they are tested against ‘best chemistry’, biologicals fall short in terms of efficacy. In some cases their mode of action requires particular climatic conditions, which may or may not exist in the environment at hand.

### OBJECT OF THE INVENTION

It is an object of preferred embodiments of the invention to at least go some way towards averting plant diseases caused by Pseudomonas syringae or Monilinia fructicola. While this object applies to preferred embodiments, it should not be seen as a limitation on claims expressed more broadly. The object of the invention per se is simply to provide the public with a useful choice.

### Definitions

The term “comprising” if and when used in this document in relation to a combination of features should not be seen as excluding the option of additional unspecified features or steps. In other words, the term should not be interpreted in a limiting way.

### SUMMARY OF THE INVENTION

According to one aspect of the invention there is provided a method of treating a plant against disease resulting from Pseudomonas bacteria or Monilinia fungi comprising applying to the plant:
a fatty acid in the form of a soap that is in solution or suspension in water; and
a silicate.

Optionally the fatty acid and silicate are applied to the plant simultaneously, for example as a formulation or other mixture.

The fatty acid may comprise a combination of different fatty acids and the silicate may comprise a combination of different silicates. Therefore the singular in this context does not exclude the plural.

The Monilinia fungi may for example comprise Monilinia fructicola.

Optionally the fatty acid and silicate are present in the weight ratio of approximately 3 parts fatty acid to 1 part silicate, or optionally plus or minus 25% on this ratio.

Optionally the fatty acid comprises one or more of:
sodium salts; and
potassium salts.

Optionally the soap and silicate kill the Pseudomonas bacteria or Monilinia fungi.

Optionally the soap and silicate inhibit the Pseudomonas bacteria or Monilinia fungi.

Optionally the soap and silicate directly control and/or directly eliminate the Pseudomonas bacteria or Monilinia fungi.

Optionally the fatty acids are derived from fats of animal origin.

Optionally the fatty acids are derived from oils of plant origin.

Optionally fatty acids are derived from fats or oils of plant or animal origin.

Optionally fatty acids comprise one or more of the following—
Caproic Acid
Caprylic Acid
Capric Acid
Lauric Acid
Myristic Acid
Palmitic Acid
Palmitoleic Acid
Stearic Acid
Oleic Acid
Linoleic Acid
Linolenic Acid
Arachidic Acid
Behenic Acid

Optionally fatty acids comprise one or more of the following*—
C6:0: Caproic Acid
C8:0: Caprylic Acid
C10:0: Capric Acid
C12:0: Lauric Acid
C14:0: Myristic Acid
C16:0: Palmitic Acid
C16:1: Palmitoleic Acid
C18:0: Stearic Acid
C18:1: Oleic Acid
C18:2: Linoleic Acid
C18:3: Linolenic Acid
C20:0: Arachidic Acid
C22:0: Behenic Acid
The number immediately following the “C” term notes the number of carbon atoms in the molecule, and the number immediately after that designates the number of double bonds in the carbon chain. So for example “06:0 Caproic acid” indicates that the molecule has ‘6’ carbon atoms and ‘0’ double bonds.

Optionally the silicate is water soluble.

Optionally the silicate is in the form of a metallic salt.

Optionally the silicate comprises one or more of:
potassium silicate;
sodium silicate; and
lithium silicate.

Optionally the molar ratio of the silicate ranges from 2.0 to 3.3. By way of example, if the silicate is potassium silicate and the molar ratio is 2.0, this means it contains 2.0 mol of SiO₂ for every 1 mol of K₂O. And if the silicate is potassium silicate at a molar ratio of 3.3, it contains 3.3 mol of SiO₂ for every 1 mol of K₂O.

Optionally the plant is one or more of a fruit, vegetable, flower, grain, mushroom (for the purpose of this document a mushroom should be taken to be optionally embraced by the term plant) or tree.

Optionally the fruit is one or more of, although not necessarily restricted to, apples, pears, peaches, nectarines, apricots, plums, cherries, tamarillos, grapes and berry fruit.

Optionally the vegetable is one or more of, although not necessarily restricted to, lettuce, brassicas, cucurbits, tomato, capsicum, chilli, potato, sweet potato, carrots, beet, spring onions, leeks, beans and peas.

Optionally the grain is one or more of, although not necessarily restricted to, wheat, maize, sorghum, oats, rice and barley.

Optionally the tree is an ornamental variety selected from one or more of, although not necessarily restricted to, magnolia, poplar, dogwood, maple, lilac and rose.

Optionally the composition comprises 45-360 g/100 L fatty acid (eg potassium soap).

Optionally the composition comprises 350-2,000 ppm silicate (eg potassium silicate).

### DRAWINGS

Some preferred embodiments of the invention will now be described by way of example and with reference to the accompanying drawings, of which:

FIGS. 1-13 graph, logarithmically, the bacterial count in the presence of solutions of potassium soaps alone, potassium silicate alone and a number of concentrations of individual potassium soaps and potassium silicate, and the efficacy effect achieved by various concentrations of potassium silicate to various concentrations of potassium soaps, when used against Pseudomonas syringae pv syringae;

FIGS. 14-26 graph spore count for potassium soaps alone, potassium silicate alone and various concentrations of individual potassium soaps and potassium silicate, and the efficacy effect achieved by the various concentrations of potassium silicate to various concentrations of potassium soaps, when used against Monilinia fructicola; and

FIGS. 27-29 graph the results of trials to assess the efficacy of various formulations against Monilinia fructicola.

### DETAILED DESCRIPTION

In a preferred embodiment of the invention there is a composition for treating plants as above against diseases as above. The composition is in the form of a spray mix solution consisting of components listed in the following examples.

### Example 1

| Component | Amount | Function |
|---|---|---|
| 18.2% w/v potassium | 500 mL-2 L | Active |
| salt(s) of fatty acid(s) in | | ingredient |
| water. (ie 182 g potassium | | |
| salt(s) of fatty acid(s) per | | |
| litre of aqueous soap | | |
| product) | | |
| 44% w/v potassium | 270-540 mL | Active |
| silicate in aqueous | (approx. 1000 | ingredient |
| solution. (ie 44% of the | ppm-2000 ppm | |
| weight of the potassium | silica) | |
| silicate aqueous solution | | |
| is potassium silicate. The | | |
| solution has a specific | | |
| gravity of approximately | | |
| 1.45. The weight of | | |
| potassium silicate per | | |
| litre of solution is | | |
| 1.45 × 44/100 = 638 | | |
| g/l of product. | | |
| Water | 100 L | Diluent - |
| | | solvent |

To produce the above composition, the silicate solution is added to about ¾ of the total water with stirring. The fatty acid potassium salt (in salt form) is then added with stirring. The balance of the water is then added with stirring.

The composition is in the form of a spray mixture ready to apply to plants by way of a manual or machine sprayer. Spraying is preferably liberal, such that excess composition runs off substantially all plant surfaces at critical plant growth stages, before disease occurs.

### Example 2

The table below lists a number of specific prototype soap formulations produced in accordance with preferred embodiments of the invention

| Formulation | Contents |
|---|---|
| NS1 | Potassium soap derived from fully refined, |
| | bleached and deodorised coconut oil (RBD |
| | Coconut Oil from Oilseed Products NZ Ltd) |
| NS2 | Potassium soap derived from fully refined, |
| | bleached deodorised palm olein (RBD Palm |
| | Olein from Oilseed Products NZ Ltd). |
| NS3 | Potassium soap derived from fully refined, |
| | bleached deodorised winterised Sunflower |
| | seed oil (RBD winterised Sunflower Oil from |
| | Oilseed Products NZ Ltd). |
| NS4 | NS4 is a Potassium soap derived from |
| | refined, pomace olive oil (Pomace Olive Oil |
| | Oilseed Products NZ Ltd) |

The formulations NS1, NS2, NS3 and NS4 were produced by saponification. In this regard 1.63 kg of the oil component in each case was reacted with 420 g of potassium hydroxide in 2.5 L water. Approximately 5 L of water was then added to make each formulation up to a final volume of 10 L. The resulting concentrated solution was then buffered to a pH of approximately 10 using citric acid based buffer. The amount of potassium salts of fatty acids in each of the “NS” soap formulation came out at approximately 18% w/v, or in other words 180 g/L soap per litre of water.

The fatty acid profile for NS1 to NS4 is generally as follows:

| NS1 | Proportion % w/w |
|---|---|
| C6:0:Caproic Acid | 0-1.0 |
| C8:0:Caprylic Acid | 8.0 |
| C10:0:Capric Acid | 6.0 |
| C12:0:Lauric Acid | 47.0 |
| C14:0:Myristic Acid | 18.0 |
| C16:0:Palmitic Acid | 9.0 |
| C18:0:Stearic Acid | 3.0 |
| C18:1:Oleic Acid | 6.0 |
| C18:2:Linoleic Acid | 2.0 |

| NS2 | Proportion % w/w |
|---|---|
| C12:0:Lauric Acid | 0-1.0 |
| C14:0:Myristic Acid | 0.5-1.5 |
| C16:0:Palmitic Acid | 37.0-42.0 |
| C18:0:Stearic Acid | 3.0-5.5 |
| C18:1:Oleic Acid | 40.0-45.0 |
| C18:2:Linoleic Acid | 9.0-13.0 |
| C18:3:Linolenic Acid | 0.0-1.0 |
| C20:0:Arachidic Acid | 0.0-1.0 |

| NS3 | Proportion % w/w |
|---|---|
| C16:0:Palmitic Acid | 6.5 |
| C18:0:Stearic Acid | 4.0 |
| C18:1:Oleic Acid | 23.0 |
| C18:2:Linoleic Acid | 58.0-64.0 |
| C18:3:Linolenic Acid | 0.5 |
| C20:0:Arachidic Acid | 0.5 |
| C22:0:Behenic Acid | 1.0 |

| NS4 | Proportion % w/w |
|---|---|
| C16:0:Palmitic Acid | 13.0 |
| C16:1:Palmitoleic Acid | 1.0 |
| C18:0:Stearic Acid | 3.0 |
| C18:1:Oleic Acid | 71.0 |
| C18:2:Linoleic Acid | 10.0 |
| C18:3:Linolenic Acid | 1.0 |
| C20:0:Arachidic Acid | 1.0 |

These NS1-4 prototype soap formulations were used in a number of in-vitro studies, both individually and in combination with potassium silicate, as described below.

In Vitro Treatment of Pseudomonas syringae PV Syringae

Laboratory trials were run to compare the effectiveness of certain embodiments of the invention against Pseudomonas syringae pv syringae. The trial measured the bacterial count observed in the presence of the following test compositions:
NS1, NS2, NS3 or NS4 alone, (each approximately 18% w/v potassium salts of fatty acids);
potassium silicate alone (concentration 44% w/v, molar ratio 2.2);
the combination of each ‘NS . . . ’ component and silicate;
Kasugamycin (an industry standard antibiotic); and
water alone.

The test compositions are listed in the table below.

| | Rate | | | | | | | | | |
|---|---|---|---|---|---|---|---|---|---|---|
| Product | Units | Treatment Rates | | | | | | | | |
| NS1 | L/100 L | 0.16 | 0.8 | 4 | | | | | | |
| NS2 | L/100 L | 0.08 | 0.4 | 2 | | | | | | |
| NS3 | L/100 L | 0.16 | 0.8 | 4 | | | | | | |
| NS4 | L/100 L | 0.16 | 0.8 | 4 | | | | | | |
| Potassium | mL/100 L | 20.8 | 104 | 520 | | | | | | |
| silicate | | | | | | | | | | |
| NS1 + | L/100 L | 0.16 | 0.16 | 0.16 | 0.8 | 0.8 | 0.8 | 4 | 4 | 4 |
| Potassium | NS1 | | | | | | | | | |
| silicate | mL/100 L | 20.8 | 104 | 520 | 20.8 | 104 | 520 | 20.8 | 104 | 520 |
| | Potassium | | | | | | | | | |
| | silicate | | | | | | | | | |
| NS2 + | L/100 L | 0.08 | 0.08 | 0.08 | 0.4 | 0.4 | 0.4 | 2 | 2 | 2 |
| Potassium | NS2 | | | | | | | | | |
| silicate | mL/100 L | 20.8 | 104 | 520 | 20.8 | 104 | 520 | 20.8 | 104 | 520 |
| | Potassium | | | | | | | | | |
| | silicate | | | | | | | | | |
| NS3 + | L/100 L | 0.16 | 0.16 | 0.16 | 0.8 | 0.8 | 0.8 | 4 | 4 | 4 |
| Potassium | NS3 | | | | | | | | | |
| silicate | mL/100 L | 20.8 | 104 | 520 | 20.8 | 104 | 520 | 20.8 | 104 | 520 |
| | Potassium | | | | | | | | | |
| | silicate | | | | | | | | | |
| NS4 + | L/100 L | 0.16 | 0.16 | 0.16 | 0.8 | 0.8 | 0.8 | 4 | 4 | 4 |
| Potassium | NS4 | | | | | | | | | |
| silicate | mL/100 L | 20.8 | 104 | 520 | 20.8 | 104 | 520 | 20.8 | 104 | 520 |
| | Potassium | | | | | | | | | |
| | silicate | | | | | | | | | |
| Water | | 1 | | | | | | | | |
| Kasugamycin | g/100 L | 40 | | | | | | | | |

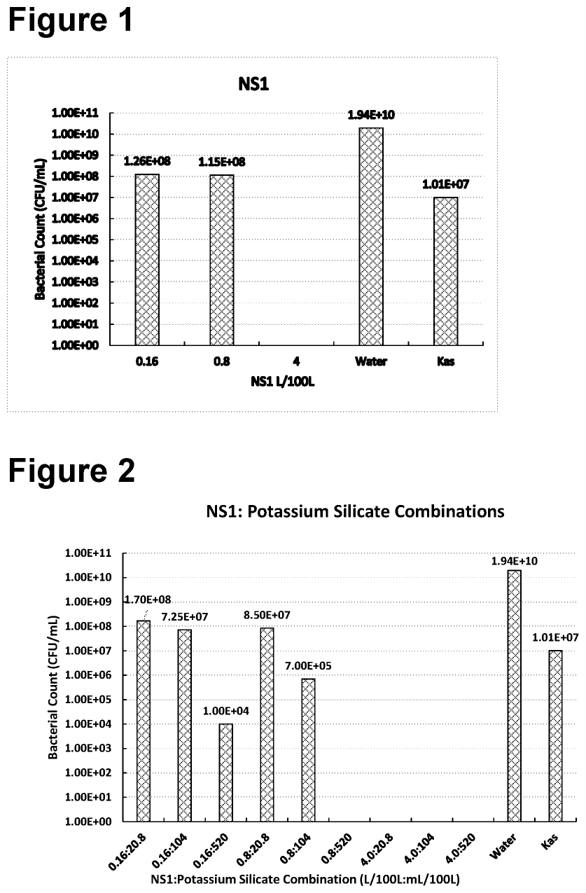

In each case a 0.5 mL aliquot of the test composition was combined with 0.5 mL of Pseudomonas syringae pv syringae bacterial suspension, making a total volume of 1 mL. The combinations were incubated for 1 hr at 20° C., then each was diluted in sterile distilled water down to 10⁻⁸. The diluted solutions were plated on Casitone-yeast extract agar (CYE agar) (Araújo et al. 2012), and incubated at 20° C. until individual bacterial colonies could be enumerated. Each solution was separately made as two true replicates. The bacterial colony count results for each sample and the percentage reduction caused by the addition of potassium silicate are as shown at FIGS. 1-13.

In Vitro Treatment of Monilinia fructicola

Laboratory trials were also run to test the effectiveness of the invention against Monilinia fructicola spores. The trial looked at spore count in the face of the following test compositions:
NS1, NS2, NS3 or NS4 alone, (each 18% w/v potassium salts of fatty acids);
potassium silicate alone, (concentration 44% w/v, molar ratio 2.2);
the combination of each ‘NS . . . ’ component and silicate;
Captan 600 Flo (an industry standard fungicide), and
water alone.

The test compositions are shown in detail in the table below.

| | Rate | | | | | | | | |
|---|---|---|---|---|---|---|---|---|---|
| Product | Units | Treatment Rates | | | | | | | |
| NS1 | L/100 L | 0.5 | 1 | 2 | 4 | | | | |
| NS2 | L/100 L | 0.5 | 1 | 2 | 4 | | | | |
| NS3 | L/100 L | 0.5 | 1 | 2 | 4 | | | | |
| NS4 | L/100 L | 0.5 | 1 | 2 | 4 | | | | |
| Potassium | mL/100 L | 135 | 270 | 405 | 540 | | | | |
| silicate | | | | | | | | | |
| NS1 + | L/100 L | 1 | 1 | 2 | 2 | | | | |
| Potassium | NS1 | | | | | | | | |
| silicate | mL/100 L | 270 | 540 | 270 | 540 | | | | |
| | Potassium | | | | | | | | |
| | silicate | | | | | | | | |
| NS2 + | L/100 L | 0.5 | 0.5 | 1 | 1 | 2 | 2 | 4 | 4 |
| Potassium | NS2 | | | | | | | | |
| silicate | mL/100 L | 270 | 540 | 270 | 540 | 270 | 540 | 270 | 540 |
| | Potassium | | | | | | | | |
| | silicate | | | | | | | | |
| NS3 + | L/100 L | 1 | 1 | 2 | 2 | | | | |
| Potassium | NS3 | | | | | | | | |
| silicate | mL/100 L | 270 | 540 | 270 | 540 | | | | |
| | Potassium | | | | | | | | |
| | silicate | | | | | | | | |
| NS4 + | L/100 L | 1 | 1 | 2 | 2 | | | | |
| Potassium | NS4 | | | | | | | | |
| silicate | mL/100 L | 270 | 540 | 270 | 540 | | | | |
| | Potassium | | | | | | | | |
| | silicate | | | | | | | | |
| Water | | | | | | | | | |
| Captan Flo | mL/100 L | 160 | | | | | | | |

Aliquots of 0.5 mL of each test composition, 0.25 ml of Monilinia fructicola spore suspension and 0.25 ml of deionised water were added to 1.5 mL tubes and mixed using a vortex mixer. The tubes were incubated at laboratory temperature (approximately 20° C.) for 3 hours. At the end of this time, the tubes were vortexed again, and 50 μl was transferred to a tube containing 4.95 mL of 2% malt extract broth (MEB). Eight 200 μl aliquots of each product were transferred to 96 well plates, with 12 products per plate. The 96 well plates were immediately placed in an automated plate reader and the optical density of each well was measured (T=0) at a wavelength of 660 nm. The covered plates were incubated at laboratory temperature (20° C. approximately) for 48 hours and optical density was measured after 24 hours (T=24) and 48 h (T=48). Spore growth (if any) was also observed visually using a binocular microscope as a check.

The measurements for each sample were averaged and the change in optical density over 48 hours was calculated. In order to compare results over different assays, efficacy was calculated as percent change in optical density of the product relative to the water control. Thus, components and component combinations that allowed spore germination and growth gave optical densities similar to the water control, and efficacies of close to zero, whereas components and component mixes that prevented spore germination and growth gave very small changes in optical density, and efficacies of close to 100%. Results for the same component and component combination tested in different assays were averaged to simplify the presentation of results. The efficacy results for each sample are as shown at FIGS. 14-26, including the change in efficacy caused by the addition of potassium silicate.

The Pseudomonas syringae pv. Syringae Bioassays

Referring to FIG. 1, the Bacterial Count (CFU/mL) of Pseudomonas syringae pv. Syringae is shown after treatment with three different rates (L/100 L) of potassium soap NS1 alone. Rates are derived logarithmically. Water and Kasugamycin (Kas) are the negative and positive controls respectively.

Referring to FIG. 2, Bacterial Count (CFU/mL) of Pseudomonas syringae pv. Syringae is shown after treatment with three different rates (L/100 L) of potassium soap NS1 in combination with 3 different rates of potassium silicate (mL/100 L). The Water and Kasugamycin (Kas) are the negative and positive controls respectively. Rates are derived logarithmically. X-axis notation represents the NS1 rate and the Potassium silicate rate. E.g. the first bar is notated ‘0.16:20.8’. This means the treatment composition was 0.16 L of NS1 per 100 L of water and 20.8 mL of potassium silicate per 100 L of water.

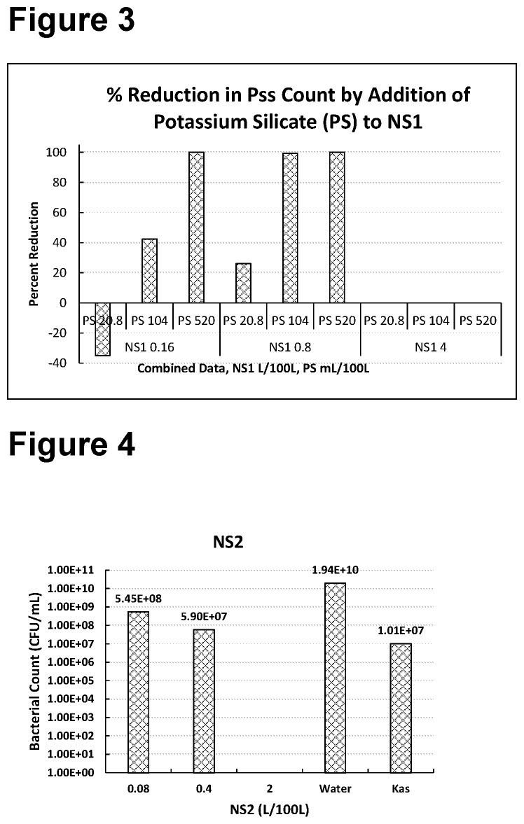

Referring to FIG. 3, the percentage reduction of Bacterial Count (CFU/mL) is shown for Pseudomonas syringae pv. Syringae as a result of the addition of potassium silicate to NS1 for each of the different rates (L/100 L) of potassium soap NS1 and the different rates of potassium silicate (mL/100 L). The first lot of three bars relate to the percent reduction caused by potassium silicate (PS) at three rates (PS 20.8, PS 104 and PS 520) when combined with potassium soap NS1 at a rate of 0.16 L/100 L. The second lot of three bars relate to the percent reduction caused by potassium silicate (PS) at three rates (PS 20.8, PS 104 and PS 520) when combined with potassium soap NS1 at a rate of 0.8 L/100 L. The percent reduction was calculated from results in FIGS. 1 and 2 as follows: (Bacterial Count NS1—Bacterial Count NS1:PS)/Bacterial Count NS1×100. Taking NS1 0.16 and PS520 as an example, (1.26×10⁸-1.00×10⁴)/1.26×10⁸×100=99.99%. NB: the lack of bars for NS1 at 4 L/100 L (NS1 4) is because NS1 alone at that rate resulted in a 0 bacterial count (ie 100% kill).

Referring to FIG. 4, Bacterial Count (CFU/mL) for Pseudomonas syringae pv. Syringae is shown after treatment with three different rates (L/100 L) of potassium soap NS2 alone. Rates are derived logarithmically. Water and Kasugamycin (Kas) are the negative and positive controls respectively.

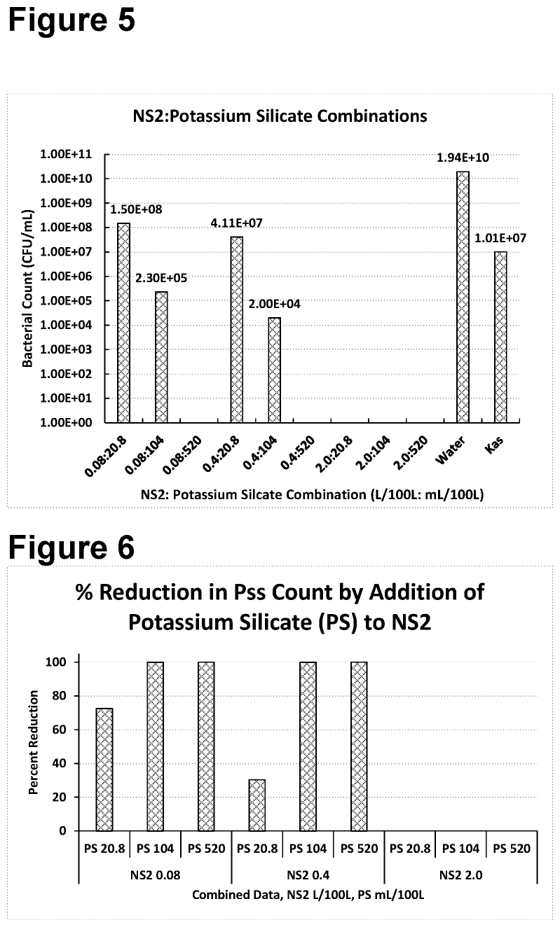

Referring to FIG. 5, Bacterial Count (CFU/mL) for Pseudomonas syringae pv. Syringae is shown after treatment with three different rates (L/100 L) of potassium soap NS2 in combination with three different rates of potassium silicate (mL/100 L). The Water and Kasugamycin (Kas) are the negative and positive controls respectively. Rates are derived logarithmically. X-axis notation represents the NS2 rate and the Potassium silicate rate. E.g. the first bar is notated ‘0.08:20.8’. This means the treatment composition was 0.08 L of NS2 per 100 L of water and 20.8 mL of potassium silicate per 100 L of water.

Referring to FIG. 6, the percentage reduction is shown for Bacterial Count (CFU/mL) of Pseudomonas syringae pv. Syringae as a result of the addition of potassium silicate to NS2 for each of the different rates (L/100 L) of potassium soap NS2 and the different rates of potassium silicate (mL/100 L). The first lot of three bars relate to the percent reduction caused by potassium silicate (PS) at three rates (PS 20.8, PS 104 and PS 520) when combined with potassium soap NS2 at a rate of 0.08 L/100 L. The second lot of three bars relate to the percent reduction caused by potassium silicate (PS) at three rates (PS 20.8, PS 104 and PS 520) when combined with potassium soap NS2 at a rate of 0.08 L/100 L. The percent reduction was calculated from results in FIGS. 4 and 5 as follows: (Bacterial Count NS2—Bacterial Count NS2:PS)/Bacterial Count NS2×100. Taking NS2 0.08 and PS520 as an example, (5.45×10⁸-0)/5.45×10⁸×100=100%. NB: the lack of bars for NS2 at 2 L/100 L (NS2 2.0) is because NS2 alone at that rate resulted in a 0 bacterial count (ie 100% kill).

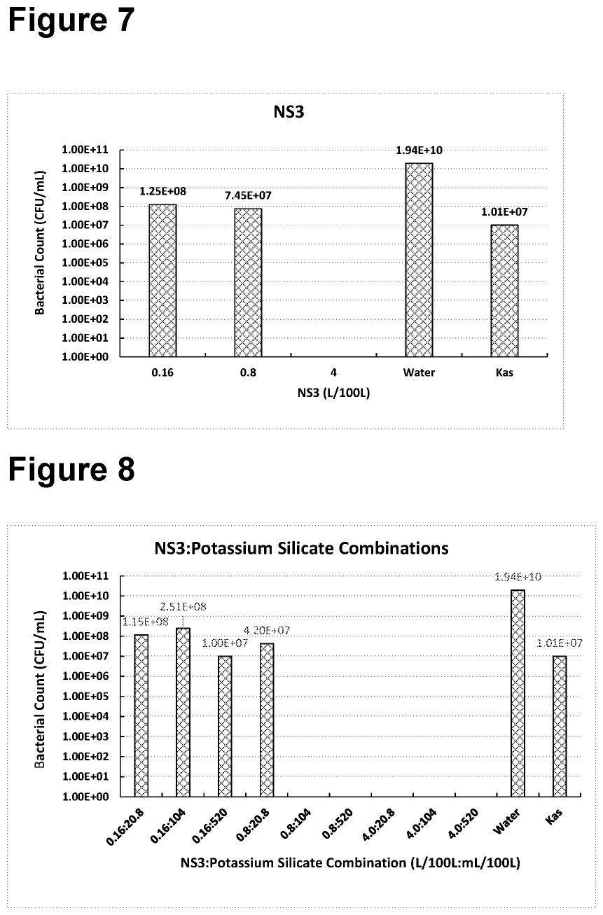

Referring to FIG. 7, Bacterial Count (CFU/mL) of Pseudomonas syringae pv. Syringae is shown after treatment with three different rates (L/100 L) of potassium soap NS3 alone. Rates are derived logarithmically. Water and Kasugamycin (Kas) are the negative and positive controls respectively.

Referring to FIG. 8, Bacterial Count (CFU/mL) of Pseudomonas syringae pv. Syringae is shown after treatment with three different rates (L/100 L) of potassium soap NS3 in combination with three different rates of potassium silicate (mL/100 L). The Water and Kasugamycin (Kas) are the negative and positive controls respectively. Rates are derived logarithmically. X-axis notation represents the NS3 rate and the Potassium silicate rate. E.g. the first bar is notated ‘0.16:20.8’. This means the treatment composition was 0.16 L of NS3 per 100 L of water and 20.8 mL of potassium silicate per 100 L of water.

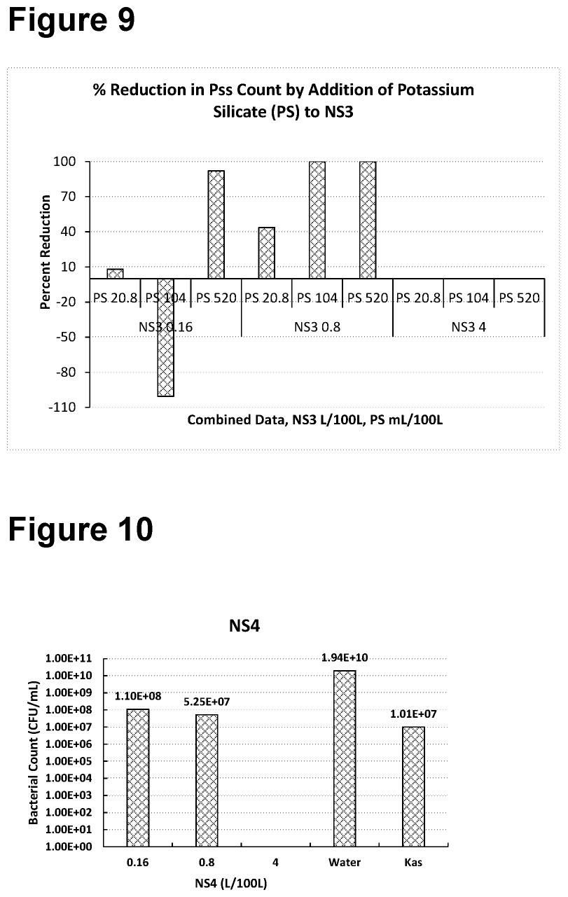

Referring to FIG. 9, the percentage reduction of Bacterial Count (CFU/mL) of Pseudomonas syringae pv. Syringae is shown as a result of the addition of potassium silicate to NS3 for each of the different rates (L/100 L) of potassium soap NS3 and the different rates of potassium silicate (mL/100 L). The first lot of three bars relate to the percent reduction caused by potassium silicate (PS) at three rates (PS 20.8, PS 104 and PS 520) when combined with potassium soap NS3 at a rate of 0.16 L/100 L. The second lot of three bars relate to the percent reduction caused by potassium silicate (PS) at three rates (PS 20.8, PS 104 and PS 520) when combined with potassium soap NS3 at a rate of 0.8 L/100 L. The percent reduction was calculated from results in FIGS. 7 and 8 as follows: (Bacterial Count NS3—Bacterial Count NS3:PS)/Bacterial Count NS3×100. Taking NS3 0.16 and PS520 as an example, (1.25×10⁸-1.0×10⁷)/1.25×10⁸×100=92%. NB: the lack of bars for NS3 at 4 L/100 L (NS3 4) is because NS3 alone at that rate resulted in a 0 bacterial count (ie 100% kill).

Referring to FIG. 10, Bacterial count (CFU/mL) for Pseudomonas syringae pv. Syringae is shown after treatment with three different rates (L/100 L) of potassium soap NS4 alone. Rates are derived logarithmically. Water and Kasugamycin (Kas) are the negative and positive controls respectively.

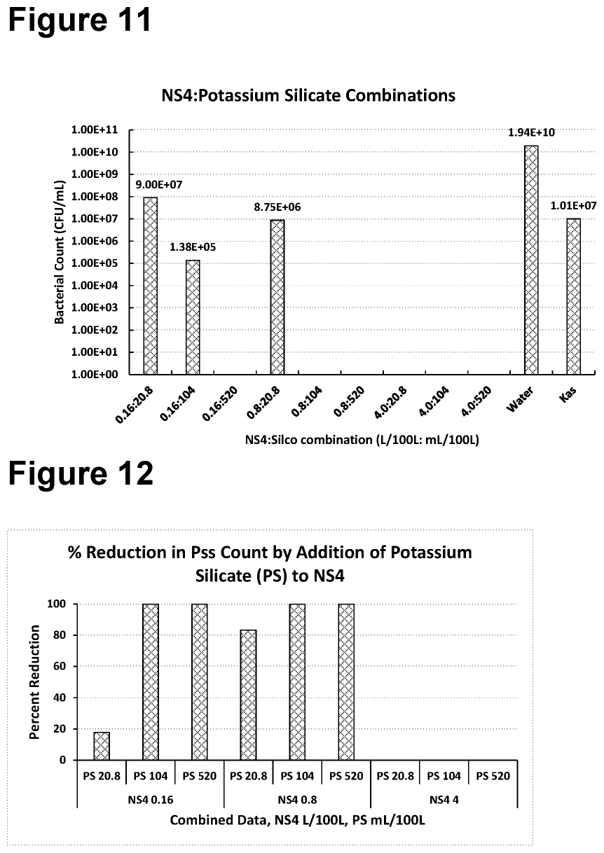

Referring to FIG. 11, Bacterial Count (CFU/mL) for Pseudomonas syringae pv. Syringae is shown after treatment with three different rates (L/100 L) of potassium soap NS4 in combination with three different rates of potassium silicate (mL/100 L). The Water and Kasugamycin (Kas) are the negative and positive controls respectively. Rates are derived logarithmically. X-axis notation represents the NS4 rate and the Potassium silicate rate. E.g. the first bar is notated ‘0.16:20.8’. This means the treatment composition was 0.16 L of NS4 per 100 L of water and 20.8 mL of potassium silicate per 100 L of water.

Referring to FIG. 12, the percentage reduction of Bacterial Count (CFU/mL) of Pseudomonas syringae pv. Syringae is shown as a result of the addition of potassium silicate to NS4 for each of the different rates (L/100 L) of potassium soap NS4 and the different rates of potassium silicate (mL/100 L). The first lot of three bars relate to the percent reduction caused by potassium silicate (PS) at three rates (PS 20.8, PS 104 and PS 520) when combined with potassium soap NS4 at a rate of 0.16 L/100 L. The second lot of three bars relate to the percent reduction caused by potassium silicate (PS) at three rates (PS 20.8, PS 104 and PS 520) when combined with potassium soap NS4 at a rate of 0.8 L/100 L. The percent reduction was calculated from results in FIGS. 10 and 11 as follows: (Bacterial Count NS4—Bacterial Count NS4:PS)/Bacterial Count NS4×100. Taking NS4 0.16 and PS520 as an example, (1.1×10⁸-0)/1.1×10⁸×100=100%. NB: the lack of bars for NS4 at 4 L/100 L (NS4 4) is because NS4 alone at that rate resulted in a 0 bacterial count (ie 100% kill).

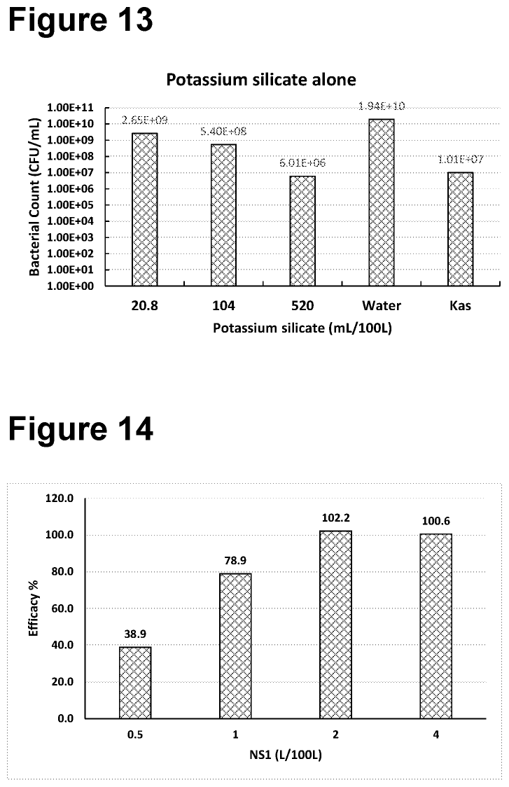

Referring to FIG. 13, Bacterial Count (CFU/mL) of Pseudomonas syringae pv. Syringae is shown after treatment with three different rates (L/100 L) of potassium silicate alone. Rates are derived logarithmically. Water and Kasugamycin (Kas) are the negative and positive controls respectively.

The Monilinia fructicola Bioassays

Referring to FIG. 14, the percent efficacy of potassium soap NS1 alone at four different rates (L/100 L) is shown against Monilinia fructicola spores. The control of Captan 600 Flo was 100% efficacious (not included). The percent efficacy was calculated as the percent change in optical density relative to the water control. Treatments that allowed spore germination and growth gave optical densities similar to the water control, and efficacies of close to zero. Treatments that prevented spore germination and growth gave very small changes in optical density, and efficacies of close to 100%.

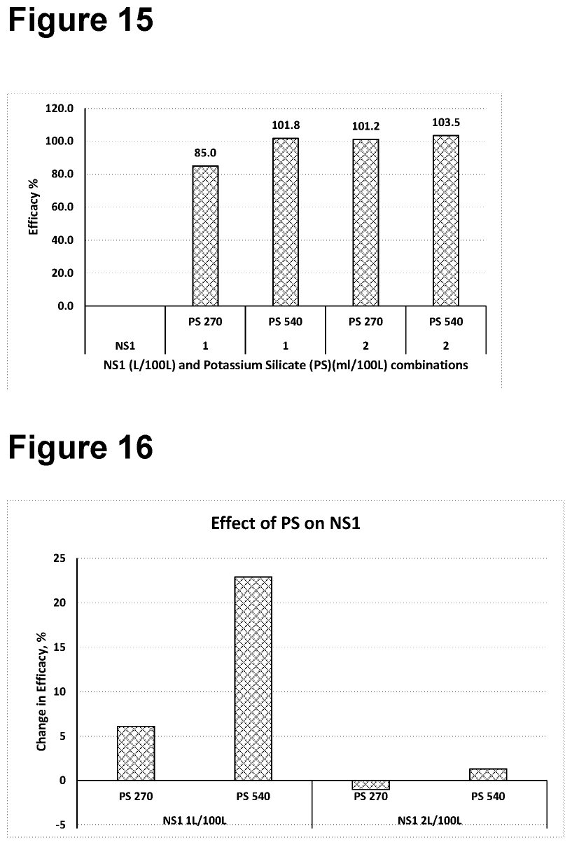

Referring to FIG. 15, the percent efficacy of potassium soap NS1 at two different rates (1 L/100 L and 2 L/100 L) in combinations with two different rates of potassium silicate (270 ml/100 L and 540 ml/100 L) is shown against Monilinia fructicola spores. The control of Captan 600 Flo was 100% efficacious (not included). The percent efficacy was calculated as the percent change in optical density relative to the water control. Treatments that allowed spore germination and growth gave optical densities similar to the water control, and efficacies of close to zero. Treatments that prevented spore germination and growth gave very small changes in optical density, and efficacies of close to 100%.

Referring to FIG. 16, the change in Percent Efficacy against Monilinia fructicola as a result of the addition of potassium silicate (PS) to NS1 is shown for each of the different rates (L/100 L) of potassium soap NS1 and the different rates of potassium silicate (mL/100 L). The change was calculated from results in FIGS. 14 and 15 being the difference between Percent Efficacy NS1 and Percent Efficacy NS1/PS for the same NS1 rate. Taking NS1 at 1 L/100 L and PS540 as an example, the percent efficacy of NS1 at 1 L/100 L is 78.9 and the percent efficacy for the same rate of NS1 with PS540 is 101.8. The difference is 22.9, indicating that the addition of potassium silicate contributed a 22.9% improvement to efficacy.

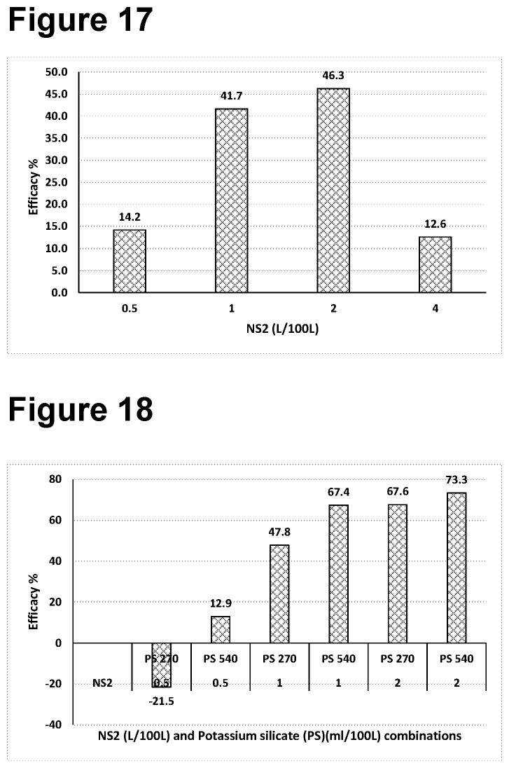

Referring to FIG. 17, the Percent Efficacy of potassium soap NS2 alone is shown at four different rates (L/100 L) against Monilinia fructicola spores. The control of Captan 600 Flo was 100% efficacious (not included). The percent efficacy was calculated as the percent change in optical density relative to the water control. Treatments that allowed spore germination and growth gave optical densities similar to the water control, and efficacies of close to zero. Treatments that prevented spore germination and growth gave very small changes in optical density, and efficacies of close to 100%.

Referring to FIG. 18, the Percent Efficacy of potassium soap NS2 is shown at four different rates (0.5 L/100 L, 1 L/100 L, 2 L/100 L and 4 L/100 L) in combinations with two different rates of potassium silicate (270 ml/100 L and 540 ml/100 L) against Monilinia fructicola spores. The control of Captan 600 Flo was 100% efficacious (not included). The percent efficacy was calculated as the percent change in optical density relative to the water control. Treatments that allowed spore germination and growth gave optical densities similar to the water control, and efficacies of close to zero. Treatments that prevented spore germination and growth gave very small changes in optical density, and efficacies of close to 100%.

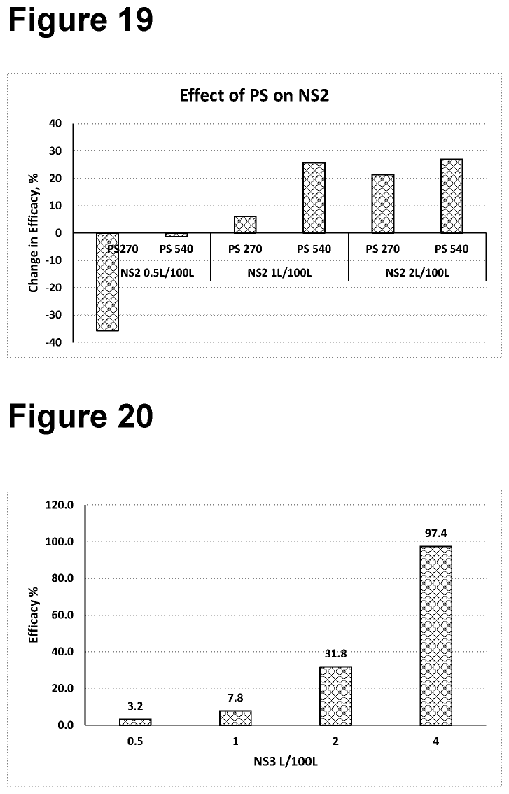

Referring to FIG. 19, the change in Percent Efficacy against Monilinia fructicola is shown as a result of the addition of potassium silicate (PS) to NS2 for each of the different rates (L/100 L) of potassium soap NS2 and the different rates of potassium silicate (mL/100 L). The change was calculated from results in FIGS. 17 and 18 being the difference between Percent Efficacy NS2 and Percent Efficacy NS2/PS for the same NS2 rate. Taking NS2 at 1 L/100 L and PS540 as an example, the percent efficacy of NS2 at 1 L/100 L is 41.7 and the percent efficacy for the same rate of NS2 with PS540 is 67.4. The difference is 25.7, indicating that the addition of potassium silicate contributed a 25.7% improvement to efficacy.

Referring to FIG. 20, the Percent Efficacy of potassium soap NS3 alone is shown at four different rates (L/100 L) against Monilinia fructicola spores. The control of Captan 600 Flo was 100% efficacious (not included). The percent efficacy was calculated as the percent change in optical density relative to the water control. Treatments that allowed spore germination and growth gave optical densities similar to the water control, and efficacies of close to zero. Treatments that prevented spore germination and growth gave very small changes in optical density, and efficacies of close to 100%.

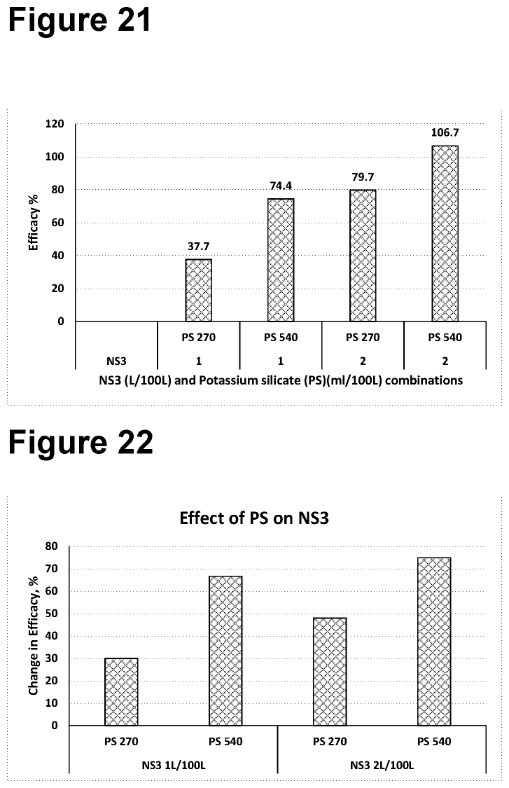

Referring to FIG. 21, the Percent Efficacy is shown for potassium soap NS3 at two different rates (1 L/100 L and 2 L/100 L) in combinations with two different rates of potassium silicate (270 ml/100 L and 540 ml/100 L) against Monilinia fructicola spores. The control of Captan 600 Flo was 100% efficacious (not included). The percent efficacy was calculated as the percent change in optical density relative to the water control. Treatments that allowed spore germination and growth gave optical densities similar to the water control, and efficacies of close to zero. Treatments that prevented spore germination and growth gave very small changes in optical density, and efficacies of close to 100%.

Referring to FIG. 22, the change in Percent Efficacy is shown against Monilinia fructicola as a result of the addition of potassium silicate (PS) to NS3 for each of the different rates (L/100 L) of potassium soap NS2 and the different rates of potassium silicate (mL/100 L). The change was calculated from results in FIGS. 20 and 21 being the difference between Percent Efficacy NS3 and Percent Efficacy NS3/PS for the same NS3 rate. Taking NS3 at 1 L/100 L and PS540 as an example, the percent efficacy of NS3 at 1 L/100 L is 7.8 and the percent efficacy for the same rate of NS3 with PS540 is 74.4. The difference is 66.6, indicating that the addition of potassium silicate contributed a 66.6% improvement to efficacy.

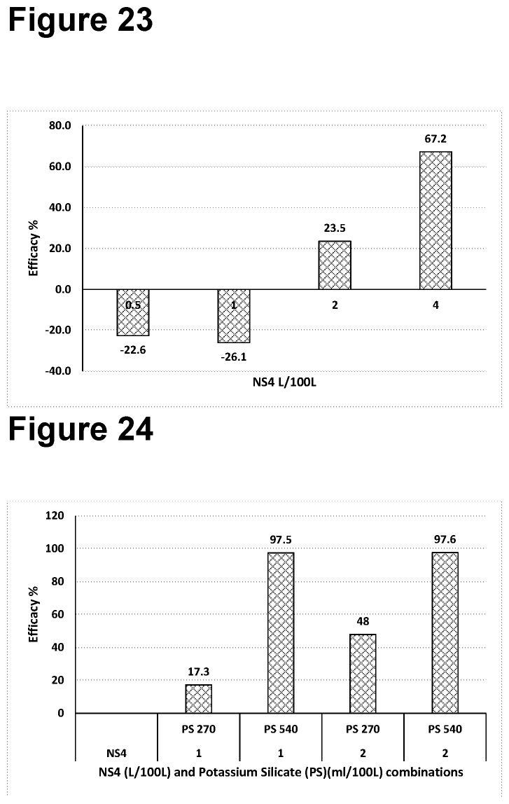

Referring to FIG. 23, the Percent Efficacy of potassium soap NS4 alone is shown at four different rates (L/100 L) against Monilinia fructicola spores. The control of Captan 600 Flo was 100% efficacious (not included). The percent efficacy was calculated as the percent change in optical density relative to the water control. Treatments that allowed spore germination and growth gave optical densities similar to the water control, and efficacies of close to zero. Treatments that prevented spore germination and growth gave very small changes in optical density, and efficacies of close to 100%.

Referring to FIG. 24, the Percent Efficacy is shown for potassium soap NS4 at two different rates (1 L/100 L and 2 L/100 L) in combinations with two different rates of potassium silicate (270 ml/100 L and 540 ml/100 L) against Monilinia fructicola spores. The control of Captan 600 Flo was 100% efficacious (not included). The percent efficacy was calculated as the percent change in optical density relative to the water control. Treatments that allowed spore germination and growth gave optical densities similar to the water control, and efficacies of close to zero. Treatments that prevented spore germination and growth gave very small changes in optical density, and efficacies of close to 100%.

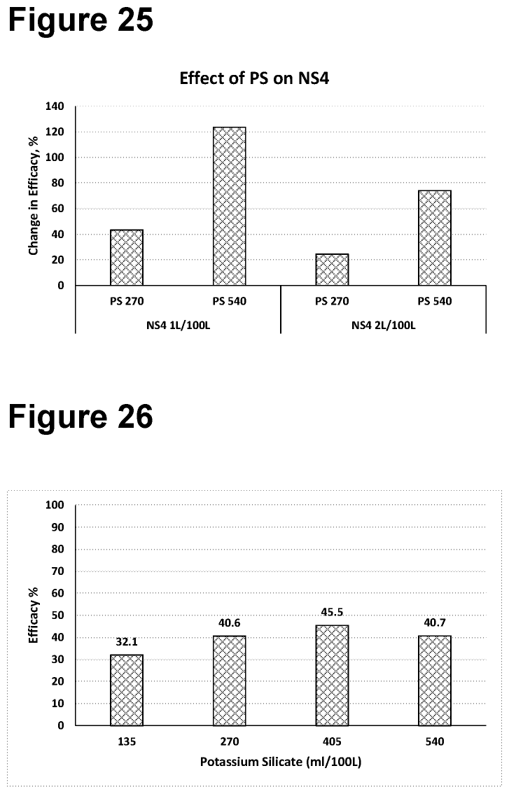

Referring to FIG. 25, the change in Percent Efficacy against Monilinia fructicola is shown, as a result of the addition of potassium silicate (PS) to NS4 for each of the different rates (L/100 L) of potassium soap NS2 and the different rates of potassium silicate (mL/100 L). The change was calculated from results in FIGS. 23 and 24 being the difference between Percent Efficacy NS4 and Percent Efficacy NS4/PS for the same NS4 rate. Taking NS4 at 1 L/100 L and PS540 as an example, the percent efficacy of NS4 at 1 L/100 L is −26.1 and the percent efficacy for the same rate of NS4 with PS540 is 97.5. The difference is 123.6, indicating that the addition of potassium silicate contributed a 123.6% improvement to efficacy.

Referring to FIG. 26, the Percent Efficacy of potassium silicate is shown, alone at four different rates (L/100 L) against Monilinia fructicola spores. The control of Captan 600 Flo was 100% efficacious (not included). The percent efficacy was calculated as the percent change in optical density relative to the water control. Treatments that allowed spore germination and growth gave optical densities similar to the water control, and efficacies of close to zero. Treatments that prevented spore germination and growth gave very small changes in optical density, and efficacies of close to 100%.

Further Studies Involving In Vitro Treatment of Monilinia fructicola

### NS2+Potassium Silicate

A further round of trials was conducted to assess the same NS2 formulation mentioned above when used against Monilinia fructicola. More specifically, two different dosage amounts of NS2 formulation when combined with different (lower) amounts of potassium silicate were tested against Monilinia fructicola. The potassium silicate is modulus 2.2, which means it contains 2.2 mol of SiO₂ for every 1 mol of K₂O and is the same potassium silicate used in the earlier described bioassays.

The combination test formulations consisted of NS2 at 1% or 2% [vol/vol] in each case in combination with one or other of the following concentrations of potassium silicate

```
  25 ml/100 L water (PS 25);
  50 ml/100 L water (PS 50);
100 ml/100 L water (PS 100);
200 ml/100 L water (PS 200);
270 ml/100 L water (PS 270);
540 ml/100 L water (PS 540).
```

Monilinia fructicola, the causal agent of brown rot in stonefruit, coded Mf GQ3 from The New Zealand Institute for Plant and Food Research Limited (PFR), Ruakura collection was grown on V8 Juice agar plates. When fungal growth covered the agar surface, the plates were flooded with 3 mL of phosphate buffer containing 0.05% Tween® 80, gently scraped to separate the fungal growth and the combined suspension was passed through a 100 μm cell strainer. The spore concentration was measured using a haemocytometer and the spore suspension was then transferred in 1 mL aliquots to storage at −20° C. The required quantity of spores was thawed for each assay.

The NS2 product and the potassium silicate were measured out at twice the desired final concentration for each test concentration (by weight, converted from volume using specific gravity) into 50 mL tubes and dissolved in deionised water. The negative control, deionised water (in duplicate) and the positive control, Captan Flo, at a final concentration of 160 mL/100 L were taken from previous assays.

Aliquots of 0.5 mL of each test composition, 0.25 ml of Monilinia fructicola spore suspension and 0.25 ml of deionised water were added to 1.5 mL tubes and mixed using a vortex mixer. The tubes were incubated at laboratory temperature (approximately 20° C.) for 3 hours. At the end of this time, the tubes were vortexed again, and 50 μl was transferred to a tube containing 4.95 mL of 2% malt extract broth (MEB). Eight 200 μl aliquots of each product were transferred to 96 well plates, with 12 products per plate. The 96 well plates were immediately placed in an automated plate reader and the optical density of each well was measured (T=0) at a wavelength of 660 nm. The covered plates were incubated at laboratory temperature (20° C. approximately) for 48 hours and optical density was measured after 24 hours (T=24) and 48 h (T=48). Spore growth (if any) was also observed visually using a binocular microscope as a check.

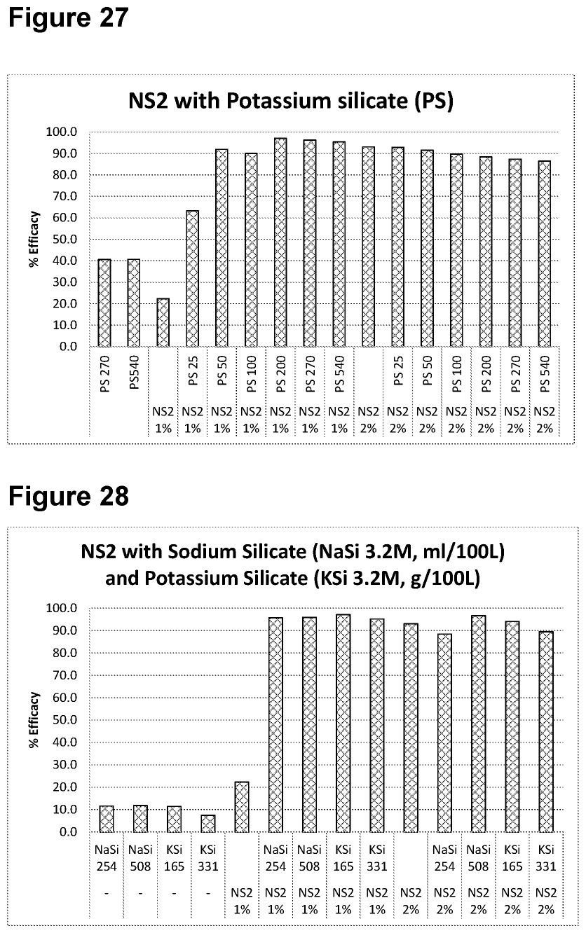

The measurements for each sample were averaged and the change in optical density over 48 hours was calculated. In order to compare results over different assays, efficacy was calculated as the percent change in optical density of the product relative to the water control. Thus, components and component combinations that allowed spore germination and growth gave optical densities similar to the water control, and efficacies of close to zero, whereas components and component mixes that prevented spore germination and growth gave very small changes in optical density, and efficacies of close to 100%. The efficacy results for each sample of the additional NS2 and potassium silicate (PS) combinations are as shown at FIG. 27 where the y-axis is Percent Efficacy.

NS2 when used alone at 1% concentrate achieves poor efficacy. The results show that NS2 at a 1% concentration can achieve very good control of Monilinia Fructicola when combined with potassium silicate at concentrations as low as 50 ml/100 L water.

The results show that NS2 at a 2% concentration can achieve very good control of Monilinia fructicola by itself. The control of Captan 600 Flo was 100% efficacious (not included).

There are benefits to the grower by using both silicates and soaps at lower concentrations together, rather than at higher concentrations alone. The main benefits are the improved efficacy for a lower rate of fatty acid product, the lowering of phytotoxic risk to crops from spraying the materials, some cost benefit and less or minimal chance of organisms becoming resistant to treatment.

### NS2+Sodium Silicate Modulus 3.2 (Coded NaSi) and NS2+Potassium Silicate Modulus 3.2 (Coded KSi)

Another test was conducted to assess the same 1% and 2% vol/vol NS2 formulations against Monilinea fructicola when combined with:
modulus 3.2 Sodium Silicate (coded NaSi); or
modulus 3.2 Potassium Silicate (coded KSi).

Modulus 3.2 Sodium Silicate (NaSi) means it contains 3.2 mol of SiO₂ for every 1 mol of Na₂O. In this case it was in an aqueous solution of 37.6% w/v concentration.

Modulus 3.2 Potassium silicate (KSi) contains 3.2 mol of SiO₂ for every 1 mol of K₂O. In this case it was in the form of a water soluble powder of 90.4% purity w/w, the remainder being water.

The Monilinea fructicola samples were prepared in the same way described above.

The NS2—NaSi combination formulations, and the NS2-KSi combination test formulations were prepared and applied in the same way as described above.

The combination test formulations consisted of NS2 at 1% or 2% vol/vol in each case in combination with one or other of the following concentrations of NaSi or KSi:

254 ml NaSi/100 L water (NaSi 254);
508 ml NaSi/100 L water (NaSi 508);
165 g KSi/100 Lwater (KSi 165);
331 g KSi/100 L water (KSi 331);

The results of the trial are shown in FIG. 28, where the ‘y’ axis is Percent Efficacy which is determined in the same way that has been previously described.

The control of Captan 600 Flo was 100% efficacious (not included).

As previously shown, the results show that NS2 at 2% can achieve very good efficacy by itself so the additional of the two silicate formulations do not significantly change that.

The results in FIG. 28 also confirm a synergistic effect with the addition of the Sodium Silicate (modulus 3.2) and Potassium silicate (Modulus 3.2) where:
Efficacy of NS2 (alone) 1%=23%
Efficacy of NaSi (alone) 254 ml/100 l=11%
Efficacy of NS2 (1%) NaSi (254 ml/100 l)=96% (synergistic effect) and
Efficacy of NS2 1%=23%
Efficacy of KSi 165 g/100 l=11%
Efficacy of NS2 (1%) and KSi (254 g/100 l)=97% (synergistic effect)

There are benefits to the grower in using combinations of materials that are physically compatible with each other that enhance the effect of either, or simply provide another mode of action against a plant pathogen at the same time. The scenario is that while a plant pathogen might be able to withstand one material that is antagonistic toward it, the chances of surviving two antagonist materials applied together are significantly lessened.

There are benefits to the grower in using both silicates and soaps at lower concentrations together, rather than higher concentration each alone. The main benefits are improved efficacy for a lower rate of fatty acid, the lowering of phytotoxic risk to crops from spraying the materials, some cost benefit and reduction of the risk of organisms becoming resistant to treatment.

### Sodium Soap (Coded NaS)+Potassium Silicate (PS)

A further test was conducted to assess efficacy of combinations of salts of fatty acids+salts of silicates against Monilinea fructicola. The test involved applying combinations of a sodium soap (coded NaS) and potassium silicate (PS Modulus 2.2) to see whether, and if so to what degree, they are effective against Monilinea fructicola.

The prototype sodium soap formulation (coded NaS) was derived from fully refined, bleached and deodorised coconut oil (RBD Coconut Oil from Oilseed Products NZ Ltd).

The formulation NaS was produced by saponification using coconut oil as a vegetable oil base the same as for the potassium soap NS1. In this regard 1.63 kg of the oil component was reacted with 270 g of sodium hydroxide in 2.5 L water. Approximately 5 L of water was then added to make the formulation up to a final volume of 10 L. The resulting concentrated solution was then buffered to a pH of approximately 10 using citric acid based buffer. The amount of sodium salts of fatty acids in the NaS soap was formulated to achieve 182 g per litre of water or approximately 18.2% w/v fatty acids of sodium salts

The weight of sodium hydroxide used with NaS to make an equivalent concentration of NS1 (a potassium soap) is considerably less. By way of explanation, this was because the potassium hydroxide used in NS1 had a purity of 90% compared with the sodium hydroxide which had a purity of 99.9%. A reduction in weight occurred also because of the molecular weight difference between potassium hydroxide (56.1 g/mol) and sodium hydroxide (40 g/mol). The fatty acid profile of NaS was the same as NS1.

In previous testing (FIG. 10) NS1 performed well alone at 1% concentration against Monilinia fructicola and it was hypothesised that NaS would perform well at that concentration. To test for synergy with potassium silicate (2.2 Modulus), the concentration rates of NaS ranged from 0.25% to 1%. The Monilinea fructicola samples were prepared in the same way described for the earlier Bioassays tests.

The potassium silicate—NaS combination formulations were prepared and applied in the same way as for the other test combinations. The combination test formulations consisted of—
270 ml PS/100 L water+0.25% vol/vol NaS;
270 ml PS/100 L water+0.5% vol/vol NaS;
270 ml PS/100 L water+0.75% vol/vol NaS;
270 ml PS/100 L water+1% vol/vol NaS;
540 ml PS/100 L water+0.25% vol/vol NaS;
540 ml PS/100 L water+0.5% vol/vol NaS;
540 ml PS/100 L water+0.75% vol/vol NaS;
540 ml PS/100 L water+1% vol/vol NaS

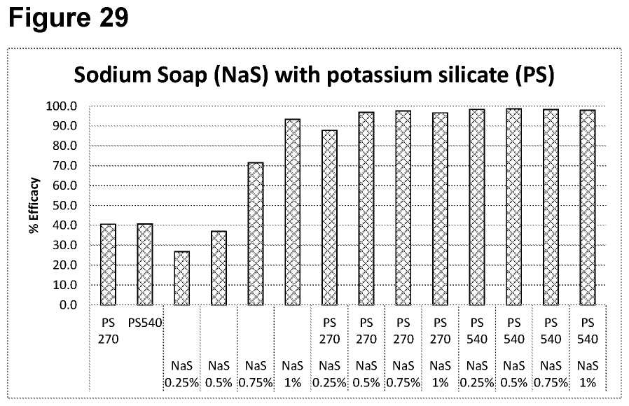

The results of the trial are shown in FIG. 29, where the ‘y’ axis is Percent Efficacy which is determined as previously described.

The results show that NaS by itself has a rate effect with the lowest (0.25%) rate being least efficacious to the 1% rate achieving a very good level of efficacy by itself.

When PS270 is added, NaS 0.5% and NaS 0.75% achieves a very good efficacy similar to NaS 1% alone. When PS540 is added, all rates of NaS achieved a very good level of efficacy.

As previously noted combinations at lower rates have benefits in terms of minimising inputs into the environment and minimising the risk of the spores becoming resistant to a single product.

The results indicate that the synergistic effects are not confined to potassium soaps and potassium silicates but extend to silicates of other metal soaps (in this case sodium).

The results also indicate that the synergistic effects are not confined to potassium soaps and potassium silicates of specific modulus, but extend to potassium soaps and potassium silicates through the range of molar ratios commercially available (in this case Modulus 3.2 instead of Modulus 2.2).

In terms of disclosure, this document envisages and hereby discloses a combination of any feature mentioned herein in combination with one or more of any of the other features herein. This applies as ‘disclosure’ even if any such combinations have been not been made the subject of any of the claims.

While some preferred embodiments of the invention have been described by way of example it should be appreciated that modifications and improvements can occur without departing from the scope of the following claims.

1. A method of treating a plant against disease resulting from Pseudomonas bacteria or Monilinia fungi, comprising applying to the plant:
a fatty acid in the form of a soap that is in solution or suspension in water; and
a silicate.

2. A method according to claim 1, wherein the fatty acid and silicate are applied as a formulation or other mixture.

3. A method according to claim 1, wherein the fatty acid comprises one or more of:
sodium salts; and
potassium salts.

4. A method according to claim 1, wherein the soap and silicate kill the Pseudomonas bacteria or Monilinia fungi.

5. A method according to claim 1, wherein the soap and silicate inhibit the Pseudomonas bacteria or Monilinia fungi.

6. A method according to claim 1, wherein the soap and silicate directly control and/or directly eliminate the Pseudomonas bacteria or Monilinia fungi.

7. (canceled)

8. (canceled)

9. (canceled)

10. A method according to claim 1, wherein the fatty acid comprises one or more of the following—
Caproic Acid
Caprylic Acid
Capric Acid
Lauric Acid
Myristic Acid
Palmitic Acid
Palmitoleic Acid
Stearic Acid
Oleic Acid
Linoleic Acid
Linolenic Acid
Arachidic Acid
Behenic Acid

11. A method according to claim 1, wherein fatty acid comprises one or more of the following—
C6:0: Caproic Acid
C8:0: Caprylic Acid
C10:0: Capric Acid
C12:0: Lauric Acid
C14:0: Myristic Acid
C16:0: Palmitic Acid
C16:1: Palmitoleic Acid
C18:0: Stearic Acid
C18:1: Oleic Acid
C18:2: Linoleic Acid
C18:3: Linolenic Acid
C20:0: Arachidic Acid
C22:0: Behenic Acid

12. A method according to claim 1, wherein the silicate is water soluble.

13. A method according to claim 1, wherein the silicate is in the form of a metallic salt.

14. A method according to claim 1, wherein the silicate comprises one or more of:
potassium silicate;
sodium silicate; and
lithium silicate.

15. A method according to claim 1, wherein the molar ratio of the silicate ranges from 2.0 to 3.3.

16. (canceled)

17. (canceled)

18. (canceled)

19. (canceled)

20. (canceled)

21. A method according to claim 1, wherein the plant is treated against disease resulting from Pseudomonas syringae pv. Syringae.

22. A method according to claim 1, wherein the plant is treated against disease resulting from Monilinia fructicola.

23. A method according to claim 1, wherein:
a) the fatty acid comprises one or more of:
sodium salts; and
potassium salts;
b) the silicate comprises one or more of:
potassium silicate;
sodium silicate; and
lithium silicate; and
c) the plant is treated against disease resulting from Pseudomonas syringae pv. Syringae.

24. A method according to claim 23, wherein the fatty acid comprises one or more of the following:
Caproic Acid;
Caprylic Acid;
Capric Acid;
Lauric Acid;
Myristic Acid;
Palmitic Acid;
Palmitoleic Acid;
Stearic Acid;
Oleic Acid;
Linoleic Acid;
Linolenic Acid;
Arachidic Acid; and
Behenic Acid.

25. A method according to claim 1, wherein
a) the fatty acid comprises one or more of:
sodium salts; and
potassium salts;
b) the silicate comprises one or more of:
potassium silicate;
sodium silicate; and
lithium silicate; and
c) the plant is treated against disease resulting from Monilinia fructicola.

26. A method according to claim 25, wherein the fatty acid comprises one or more of the following—
Caproic Acid;
Caprylic Acid;
Capric Acid;
Lauric Acid;
Myristic Acid;
Palmitic Acid;
Palmitoleic Acid;
Stearic Acid;
Oleic Acid;
Linoleic Acid;
Linolenic Acid;
Arachidic Acid; and
Behenic Acid.

27. A method according to claim 23, wherein the molar ratio of the silicate ranges from 2.0 to 3.3.

28. A method according to claim 25, wherein the molar ratio of the silicate ranges from 2.0 to 3.3.
